(19) United States
(12) Patent Application Publication
(10) Pub. No.: US 2008/0176031 A1
(43) Pub. Date: Jul. 24, 2008

(54) PROTECTIVE PACKAGING FOR ROLLS

(75) Inventor: Michael Landry, Attleboro, MA (US)

Correspondence Address: BARLOW, JOSEPHS & HOLMES, LTD., 101 DYER STREET, 5TH FLOOR, PROVIDENCE, RI, 02903, US

(73) Assignee: MULTI-WALL PACKAGING CORPORATION, East Providence, RI (US)

(21) Appl. No.: 11/962,205

(22) Filed: Dec. 21, 2007

Related U.S. Application Data
(60) Provisional application No. 60/885,417, filed on Jan. 18, 2007.

(51) Int. Cl. B32B 3/00; B05D 3/00; B05D 5/10; B05D 1/00

(52) U.S. Cl. 428/121; 427/299; 427/207.1; 427/180

(57) ABSTRACT

An edge protector for rolled materials and method of making thereof is disclosed. The edge protector includes a base substrate having a front surface and a back surface. The base substrate has an elongated lower portion and a plurality of fingers extending from one portion of the lower portion. The plurality of fingers is configured and arranged to fold substantially ninety degrees inwardly from the lower portion. A polymer coating is applied to at least one of the front surface and the back surface of the base substrate.

### CROSS-REFERENCE TO RELATED APPLICATION

The present application claims priority to earlier filed U.S. Provisional Patent Application Ser. No. 60/885,417, filed on Jan. 18, 2007, the entire contents of which are incorporated by reference.

### BACKGROUND OF THE INVENTION

1. Field of the Invention

The present invention relates to packaging for shipping and storage of materials and more particularly to an edge protector for materials that the rolled or coiled.

2. Background of the Related Art

Rolled materials present unique problems to packaging, shipping and storage. Rolled materials include metal and foil rolls and coils, paper rolls, plastic film rolls, laminated products that are rolled, fabrics, and other non-woven rolled materials. These rolled materials may be rolled onto an internal spool or upon themselves without the use of a spool. In either case, protecting the outer edges of the rolled material during storage and shipping from crushing and abrasion is important. The mass, lengths and diameters of these rolled materials vary considerably; from mere pounds in mass and inches in length and diameter to tons in mass and feet in length and diameter.

However, the means for protecting the edges of the rolled material must still be inexpensive and lightweight. Moreover, it must be strong enough to resist the rigors of being stored, shipped and jostled. Therefore, there is a perceived need for an article that can protect the edges of rolled materials that is light weight and inexpensive, yet strong enough to resist damage from crushing and abrasive forces against the edges of the rolled material.

### SUMMARY OF THE INVENTION

The edge protector of the present invention provides a unique solution to protecting the edges of rolled materials. In particular, the edge protector includes a base substrate having a front surface and a back surface. The base substrate has an elongated lower portion and a plurality of fingers extending from one portion of the lower portion. The plurality of fingers is configured and arranged to fold substantially ninety degrees inwardly from the lower portion. A polymer coating is applied to at least one of the front surface and the back surface of the base substrate.

### BRIEF DESCRIPTION OF THE DRAWINGS

These and other features, aspects, and advantages of the present invention will become better understood with reference to the following description, accompanying drawings and claims where:

FIG. 1 a perspective view of a coil of the edge protector of the preferred embodiment of the present invention;

FIG. 2a a cross-section view of a first embodiment of the edge protector of the present invention with an adhesive backed paper applied to one surface of the base substrate;

FIG. 2b a cross-section view of a second embodiment of the edge protector of the present invention as in FIG. 2a, but with adhesive backed paper applied on both sides of the base substrate;

FIG. 3a a cross-section of a third embodiment of the edge protector of the present invention having two layers of adhesive backed paper applied to the base substrate;

FIG. 3b is a cross-section view of a fourth embodiment that has both sides of the base substrate having two layers of adhesive backed paper on each side;

FIG. 4 is a partial perspective view of the edge protector applied to the end of a roll of material, such as a roll of paper; and

FIG. 5 is a flow chart of a method of forming a packaging protector of rolls.

### DETAILED DESCRIPTION OF THE PREFERRED EMBODIMENT

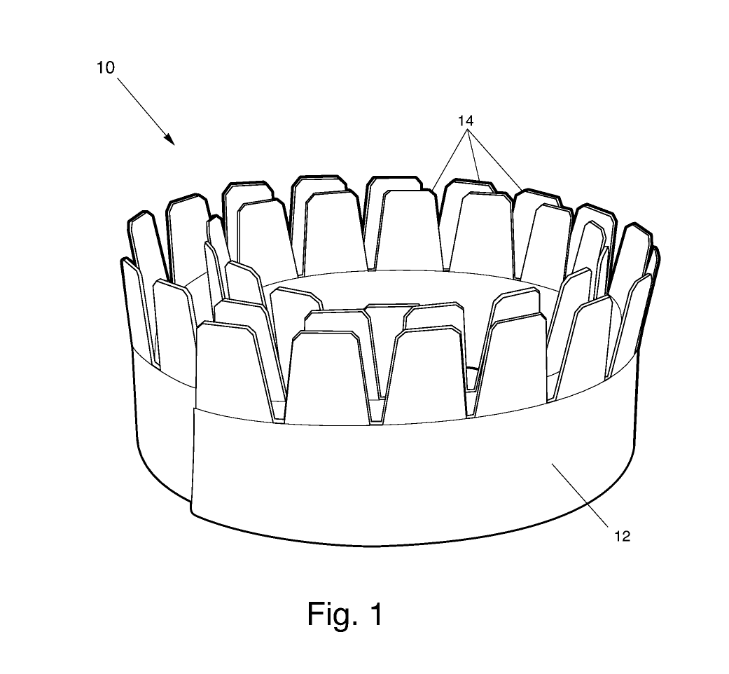

Referring now to FIG. 1, the edge protector 10 of the present invention provides a unique solution to protecting the edges of rolled materials. In particular, the edge protector 10 the present invention has a lower portion 12 having a plurality of fingers 14 extending therefrom. The edge protector 10 includes a base substrate 16 that may be formed from paperboard, such as chipboard boxboard or corrugated fiberboard. Additionally, thermoplastic materials may be used. Multiple layers or plies may be used to form a heavier, more rigid or reinforced edge protector 10.

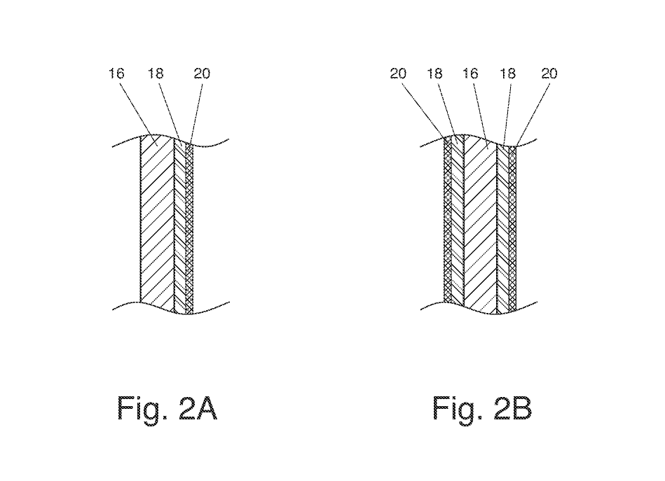

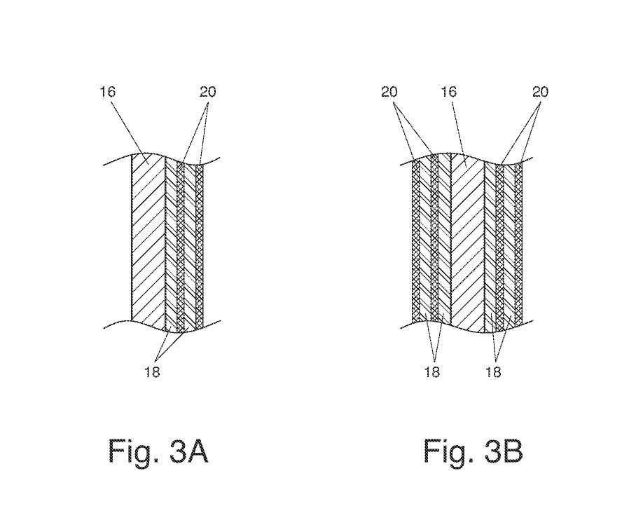

Referring to FIG. 2a, the base substrate 16 of the edge protector 10 of the present invention may also be coated with an adhesive backed paper 18 and then subsequently coated with a polymer coating 20 to further enhance the strength of the edge protector 10. The adhesive backed paper 18 with polymer coating 20 may be applied to both the front and back surface of the base substrate 16 of the edge protector 10 as shown in FIG. 2b. Additionally, multiple layers of adhesive backed paper 18 may be applied to further reinforce the edge protector 10, as shown in FIGS. 3a and 3b. Although only two layers are shown, three or more layers of adhesive backed paper 18 may be applied to each side of the base substrate 16 of the edge protector 10 also.

The polymer coating 20 serves multiple purposes. It provides strength and durability to the laminated product base substrate 16, 18. In particular, the polymer coating 20 enhances the strength of the edge protector 10 and prevents the fingers 14 from cracking and breaking off. It also provides a non-abrasive, cushioning surface to protect the end user's roll products 22. The polymer coating 20 also serves as a moisture barrier to protect both the base laminate substrate 16, 18 from absorbing moisture, and from allowing moisture to come in contact with the end user's material 22 on the rolls or coils. The polymer coating 20 protects laminate base substrate 16, 18 from absorbing contaminates or fugitives, such as process oils from customer roll materials which may deteriorate the edge protector 10, or contaminate outer packaging or adjacent items.

Suitable polymers may consist of the polyethylene, polyolefin, polyester or polyurethane families. The polymer coatings 20 may be applied to the adhesive backed paper 18 in a film form, extrusion coating, powder coating or emulsion coating.

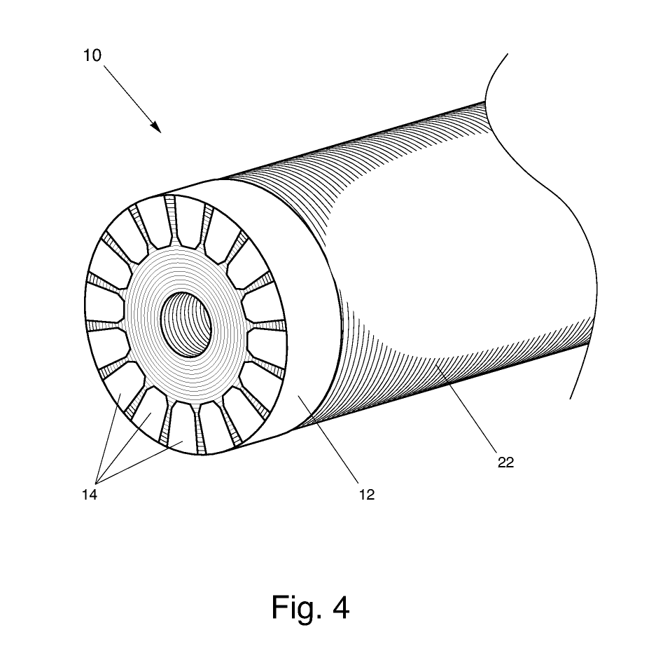

Referring to FIG. 4, in use, the lower portion 12 is wrapped around the circumference of the rolled material 22 and the fingers 14 are bent over 90° to point radially inward towards the center of the rolled material 22. The edge protector 10 is cut to an appropriate size to substantially cover the circumference of the rolled material 22.

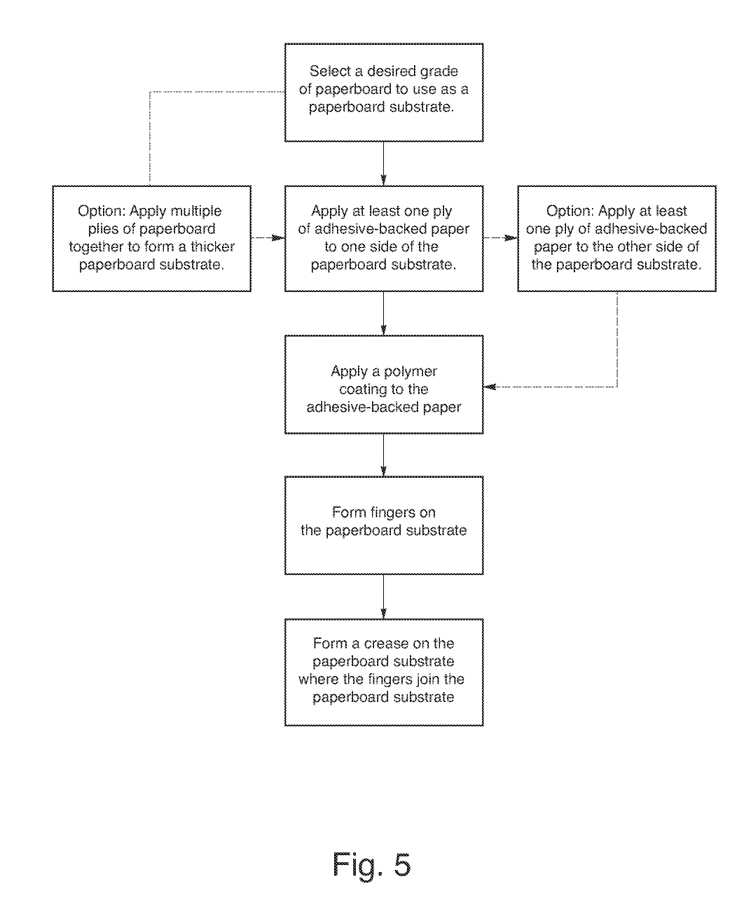

Referring now to FIG. 5, the edge protector 10 is produced may be produced in a continuous length, in a variety of special shapes via rotary or reciprocating methods of die cutting. The specific shape(s) and length allow wrapping the outer and inner diameters of rolls and coils offering protection against damage. Shapes are varied via differing die patterns and are application specific. Lengths of the edge protector 10 vary based upon end user requirements or limitations.

The base substrate 16 of the edge protector 10 may be produced from a multi-ply lamination which includes two outer surface layers of polymer coated 20, adhesive backed paper 18, and an inner ply, or plies, of paperboard.

The adhesive backed paper 18 can a.) be coated with polymer 20 in a step prior to the lamination of the roll edge protector base material 16, in a separate process, resulting in a discreet, polymer coated adhesive backed paper product, or, b.) the polymer 20 may be applied after the adhesive backed paper 18 is applied to the laminated base substrate 16.

Therefore, it can be seen that the present invention provides a unique solution to the problem of providing an edge protector for rolled materials that has increased strength and durability over the prior art, yet is still lightweight and inexpensive to manufacture.

It would be appreciated by those skilled in the art that various changes and modifications can be made to the illustrated embodiments without departing from the spirit of the present invention. All such modifications and changes are intended to be within the scope of the present invention except as limited by the appended claims.

I claim:

1. An edge protector for rolled materials, comprising:
a base substrate having a front surface and a back surface, said base substrate having an elongated lower portion and a plurality of fingers extending from one portion of the lower portion, said plurality of fingers configured and arranged to fold substantially ninety degrees inwardly from the lower portion; and
a polymer coating applied to at least one of the front surface and the back surface of the base substrate.

2. The edge protector of claim 1, wherein the base substrate further comprises at least one layer of adhesive backed paper.

3. The edge protector of claim 1, wherein the base substrate further comprises at least one layer of paperboard.

4. The edge protector of claim 3, wherein said paperboard is chipboard.

5. The edge protector of claim 3, wherein said paperboard is boxboard.

6. The edge protector of claim 3, wherein said paperboard is corrugated fiberboard.

7. The edge protector of claim 3, wherein the base substrate further comprises at least one layer of thermoplastic material.

8. The edge protector of claim 1, wherein the polymer coating is selected from the group consisting essentially of polyethylene, polyolefin, polyester, and polyurethane.

9. A method of making an edge protector for rolled materials, comprising the steps of:
forming a base substrate having a front surface and a back surface;
forming a lower portion and a plurality of fingers extending from the lower portion from the base substrate, said plurality of fingers configured and arranged to fold substantially ninety degrees inwardly; and
applying a polymer coating to at least one of the front surface and the back surface of the base substrate.

10. The method of claim 9, wherein the step of forming a base substrate further comprises the step of:
selecting a desired grade of paperboard to form the base substrate;

11. The method of claim 9, wherein the step of forming a base substrate further comprises the step of:
forming multiple layers of paperboard together to form a base substrate that is laminated.

12. The method of claim 9, wherein the step of forming a base substrate further comprises the step of:
applying at least one layer of adhesive backed paper to at least one of the front surface and the back surface of the base substrate;

13. The method of claim 9, wherein the step of applying a polymer coating comprises applying a film of a polymer to at least one of the front surface and the back surface of the base substrate.

14. The method of claim 9, wherein the step of applying a polymer coating comprises extrusion coating a polymer to at least one of the front surface and the back surface of the base substrate.

15. The method of claim 9, wherein the step of applying a polymer coating comprises powder coating a polymer to at least one of the front surface and the back surface of the base substrate.

16. The method of claim 9, wherein the step of applying a polymer coating comprises emulsion coating a polymer to at least one of the front surface and the back surface of the base substrate.

17. An edge protector for rolled materials, comprising:
a paperboard substrate having a front surface and a back surface, said paperboard substrate having an elongated lower portion and a plurality of fingers extending from one portion of the lower portion, said plurality of fingers configured and arranged to fold substantially ninety degrees inwardly from the lower portion;
at least one layer of adhesive backed paper applied to at least one of the front surface and the back surface of the paperboard substrate; and
a polymer coating applied to the adhesive backed paper.

18. The edge protector of claim 17, wherein said paperboard substrate is selected from the group consisting essentially of: boxboard, chipboard and corrugated fiberboard.

19. The edge protector of claim 17, wherein the polymer coating is selected from the group consisting essentially of polyethylene, polyolefin, polyester, and polyurethane.

20. The edge protector of claim 17, wherein the paperboard substrate comprises at least one layer of paperboard.
